(19) United States
(12) Patent Application Publication
(10) Pub. No.: US 2016/0358259 A1
(43) Pub. Date: Dec. 8, 2016

(54) AGGREGATING ACCOUNT INFORMATION OBTAINED FROM MULTIPLE INSTITUTIONS

(71) Applicant: Bank of America Corporation, Charlotte, NC (US)

(72) Inventors: Salvatore Cucchiara, Windsor, NJ (US); Philip P. Francisco, Robbinsville, NJ (US); Rajesh Natarajan, Kendall Park, NJ (US); John Scully, Hamilton Square, NJ (US); Thomas Fahey, Kendall Park, NJ (US); Neeta Gupta, Millstone, NJ (US)

(21) Appl. No.: 14/732,085

(22) Filed: Jun. 5, 2015

(51) Int. Cl. G06Q 40/06; H04L 29/06; G06F 21/62

(52) U.S. Cl. CPC G06Q 40/06; G06F 21/6245; H04L 63/08

(57) ABSTRACT

Methods, systems, and computer-readable media for retrieving and presenting financial data are presented. In some embodiments, a computer system associated with a financial institution may retrieve, via a financial aggregator application, financial data associated with a customer's account at a different financial system. Subsequently, the computer system may aggregate data from a customer's account with the financial institution and data from the customer's account at the different financial system. The aggregated data may be presented for viewing to a financial advisor associated with the customer.

### BACKGROUND

Aspects of the disclosure relate to computer hardware and software. In particular, one or more aspects of the disclosure generally relate to computer hardware and software for aggregating financial data from one or more financial accounts.

A financial advisor often may provide a customer with financial products and services, such as financial planning. Financial advisors, for example, may advise clients on how to best save, utilize, and increase their financial assets. Financial advisors may help customers establish and achieve a financial goal. To maximize the effectiveness of a financial advisor, a financial advisor may wish to have a complete and precise knowledge of a customer's financial portfolio. This may include, for instance, information about the customer's banking accounts at one or more financial institutions, brokerage accounts at one or more financial institutions, real estate holdings, insurance plans, retirement plans, or any other type of financial asset(s) held by the customer.

In some instances, a financial advisor may be associated with a financial institution and may provide financial planning for a customer of the financial institution. In these instances, the financial advisor's view of the customer's financial portfolio may be limited to the financial accounts maintained for the customer by the financial institution. This incomplete view of the customer's financial holdings may detrimentally affect the financial advisor's ability to effectively advise the customer. In many instances, however, it may be to provide such a financial advisor with a complete view of the customer's financial portfolio that includes information on both the financial accounts maintained for the customer by the financial institution as well as information on the financial accounts maintained for the customer by one or more other financial institutions.

### SUMMARY

Aspects of the disclosure relate to various systems and techniques that provide effective, efficient, and convenient ways of providing a financial advisor with a complete summary of a customer's financial assets.

Aspects of the disclosure relate to enabling one or more computer systems of a financial institution to connect to and request third-party account data from remote computer systems that are associated with one or more third-party financial institutions. The one or more computer systems of the financial institution may locally compile the third-party account data received from the remote computer systems associated with one or more third-party financial institutions and may further locally compile account data associated with the financial institution. The one or more computer systems of the financial institution may present the compiled data to one or more financial advisors associated with the financial institution via one or more computing platforms. The one or more computing platforms may be mobile computing platforms or may be desktop-based computing platforms. Advantageously, aspects of the disclosure may enable one or more computer systems of a financial institution to enable financial advisors associated with the financial institution to view third-party account information, such as account balance information, and to perform financial analysis based on third-party account information.

For example, in accordance with one or more aspects of the disclosure, a first computing platform comprising at least one processor, a communication interface, and memory may receive, via the communication interface and from a customer computing device, an authorization message from a customer of a first financial institution, the authorization message comprising authorization information indicating that the customer has authorized the first financial institution to access data related to a third-party financial account maintained for the customer by a second financial institution different than the first financial institution. The computing platform may store the authorization message and an identification of a financial advisor associated with the customer in an external account record associated with the customer of the first financial institution. The external account record may be maintained in a database. The computing platform may retrieve, via the communication interface and from one or more computer servers associated with an external aggregator, financial data related to the third-party financial account. The computing platform may store the financial data related to the third-party financial account in a central account data repository. The computing platform may provide, via the communication interface, to a financial advisor computing device used by the financial advisor associated with the customer, an advisor portal user interface, the advisor portal user interface comprising at least a portion of the financial data related to the third-party financial account maintained for the customer by the second financial institution different than the first financial institution, and the advisory portal user interface further comprising second financial data related to a first financial account maintained for the customer by the first financial institution.

In some instances, the computing platform may receive, via the communication interface, from the customer computing device, a second authorization message from the customer comprising second authorization information indicating that the customer has authorized the first financial institution to access data related to a second third-party financial account maintained for the customer by a third financial institution different than the first financial institution and the second financial institution. The computing platform may store, in the external account record associated with the customer of the first financial institution, the second authorization information. The external account record may be maintained in a database. The computing platform may retrieve third financial data related to the second third-party financial account. The computing platform may provide, to the advisor portal user interface, the third financial data related to the second third-party financial account. The computing platform may further retrieve third financial data related to the second third-party financial account comprises retrieving, via the communication interface, from the one or more computer servers associated with the external aggregator, third financial data related to the second third-party financial account. The computing platform may further retrieve via the communication interface, from one or more computer servers associated with a second external aggregator different than the external aggregator, third financial data related to the second third-party financial account.

In some instances, the computing platform may receive, via the communication interface, from a second customer computing device, a second authorization message from a second customer of the first financial institution, the second authorization message comprising second authorization information indicating that the second customer has authorized the first financial institution to access data related to a second third-party financial account maintained for the second customer by a third financial institution different than the first financial institution, wherein the second customer is different than the customer. The computing platform may store the second authorization information in a second external account record associated with the second customer. The second external account record may be maintained in a database. The computing platform may retrieve, via the communication interface, from the one or more computer servers associated with the external aggregator, third financial data related to the second third-party financial account. The computing platform may store the third financial data related to the second third-party financial account in the central account data repository. The computing platform may provide, via the communication interface, to a second financial advisor computing device used by a second financial advisor associated with the second customer, a second advisor portal user interface, the second advisor portal user interface comprising at least a portion of the third financial data related to the second third-party financial account maintained for the second customer by the third financial institution, and the second advisory portal user interface further comprising fourth financial data related to a second financial account maintained for the second customer by the first financial institution. The financial advisor and the second financial advisor may be the same. The financial advisor and the second financial advisor may be different. The computing platform may further send, via the communication interface, to a computing platform associated with the first financial institution and configured to provide one or more of an analytical modeling platform, an asset allocation platform, and a client reporting platform, the financial data related to the third-party financial account for processing.

In accordance with one or more embodiments, a system may comprise at least one processor, a communication interface, and memory storing computer-readable instructions that, when executed by the at least one processor, cause the system to receive, via the communication interface, from a customer computing device, an authorization message from a customer of a first financial institution, the authorization message comprising authorization information indicating that the customer has authorized the first financial institution to access data related to a third-party financial account maintained for the customer by a second financial institution different than the first financial institution. The memory may store additional computer-readable instructions that, when executed by the at least one processor, further cause the system to store the authorization information in an external account record associated with the customer and maintained in a database. The memory may store additional computer-readable instructions that, when executed by the at least one processor, further cause the system to receive, via the communication interface, from one or more computer servers associated with an external aggregator, financial data related to the third-party financial account. The memory may store additional computer-readable instructions that, when executed by the at least one processor, further cause the system to store the financial data related to the third-party financial account in a central account data repository. The memory may store additional computer-readable instructions that, when executed by the at least one processor, further cause the system to provide, via the communication interface, to a financial advisor computing device used by a financial advisor associated with the customer, an advisor portal user interface, the advisor portal user interface comprising at least a portion of the financial data related to the third-party financial account maintained for the customer by the second financial institution different than the financial institution, and the advisory portal user interface further comprising second financial data related to a first financial account maintained for the customer by the first financial institution.

In one instance, the memory may store additional computer-readable instructions that, when executed by the at least one processor, further cause the system to receive, via the communication interface, from the customer computing device, a second authorization message from the customer comprising second authorization information indicating that the customer has authorized the first financial institution to access data related to a second third-party financial account maintained for the customer by a third external financial institution different than the first financial institution and the second financial institution. The memory may store additional computer-readable instructions that, when executed by the at least one processor, further cause the system to store the second authorization information in the external account record associated with the customer. The memory may store additional computer-readable instructions that, when executed by the at least one processor, further cause the system to retrieve third financial data related to the second third-party financial account. The memory may store additional computer-readable instructions that, when executed by the at least one processor, further cause the system to provide, to the advisor portal user interface, the third financial data related to the second third-party financial account maintained for the customer by the third financial institution. Retrieving third financial data related to the second third-party financial account may comprise retrieving, via the communication interface, from the one or more computer servers associated with the external aggregator, third financial data related to the second third-party financial account. Retrieving financial data related to the second third-party financial account may comprise retrieving, via the communication interface, from one or more computer servers associated with a second external aggregator, financial data related to the second third-party financial account

In one instance, the memory may store additional computer-readable instructions that, when executed by the at least one processor, further cause the system to receive, via the communication interface, from a second customer computing device, a second authorization message from a second customer of the first financial institution, the second authorization message comprising second authorization information indicating that the second customer has authorized the first financial institution to access data related to a second third-party financial account maintained for the second customer by a third financial institution different than the first financial institution, wherein the second customer is different than the customer. The memory may store additional computer-readable instructions that, when executed by the at least one processor, further cause the system to store the second authorization message in a second external account record associated with the second customer. The second external account record may be maintained in the database. The memory may store additional computer-readable instructions that, when executed by the at least one processor, further cause the system to retrieve, via the communication interface, from the one or more computer servers associated with the external aggregator, third financial data related to the second third-party financial account. The memory may store additional computer-readable instructions that, when executed by the at least one processor, further cause the system to store the third financial data related to the second third-party financial account in the central account data repository. The memory may store additional computer-readable instructions that, when executed by the at least one processor, further cause the system to provide, via the communication interface, to a second financial advisor computing device used by a second financial advisor associated with the second customer, a second advisor portal user interface, the second advisor portal user interface comprising at least a portion of the third financial data related to the second third-party financial account maintained for the second customer by the third financial institution, and the second advisory portal user interface further comprising fourth financial data related to a second financial account maintained for the second customer by the first financial institution. The financial advisor and the second financial advisor may be the same. The financial advisor and the second financial advisor may be different.

In one instance, retrieving, via the communication interface, from the one or more computer servers associated with the external aggregator, financial data related to the third-party financial account comprises periodically retrieving, via the communication interface, from the one or more computer servers associated with the external aggregator, financial data related to the third-party financial account. In another instance, the memory may store additional computer-readable instructions that, when executed by the at least one processor, further cause the system to provide, to the advisor portal user interface, an asset allocation based on the financial data related to the third-party financial account and the second financial data related to the first financial account. In another instance, the memory may store additional computer-readable instructions that, when executed by the at least one processor, further cause the system to send, via the communication interface, to a computing platform associated with the first financial institution and configured to provide an analytical modeling platform, the financial data related to the third-party financial account for processing by the analytical modeling platform. In another instance, the memory may store additional computer-readable instructions that, when executed by the at least one processor, further cause the system to send, via the communication interface, to a computing platform associated with the first financial institution and configured to provide a client reporting platform, the financial data related to the third-party financial account for processing by the client reporting platform.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for aggregating financial data from one or more financial accounts maintained for a customer by one or more financial institutions into a portal in accordance with one or more example embodiments;

FIGS. 4A-4C depict an illustrative event sequence for aggregating financial data from one or more financial accounts maintained for a customer by one or more financial institutions into a portal in accordance with one or more example embodiments;

FIG. 5 depicts an example graphical user interface for aggregating financial data from one or more financial accounts maintained for a customer by one or more financial institutions into a portal in accordance with one or more example embodiments; and

FIG. 6 depicts an illustrative method for aggregating financial data from one or more financial accounts maintained for a customer by one or more financial institutions into a portal in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

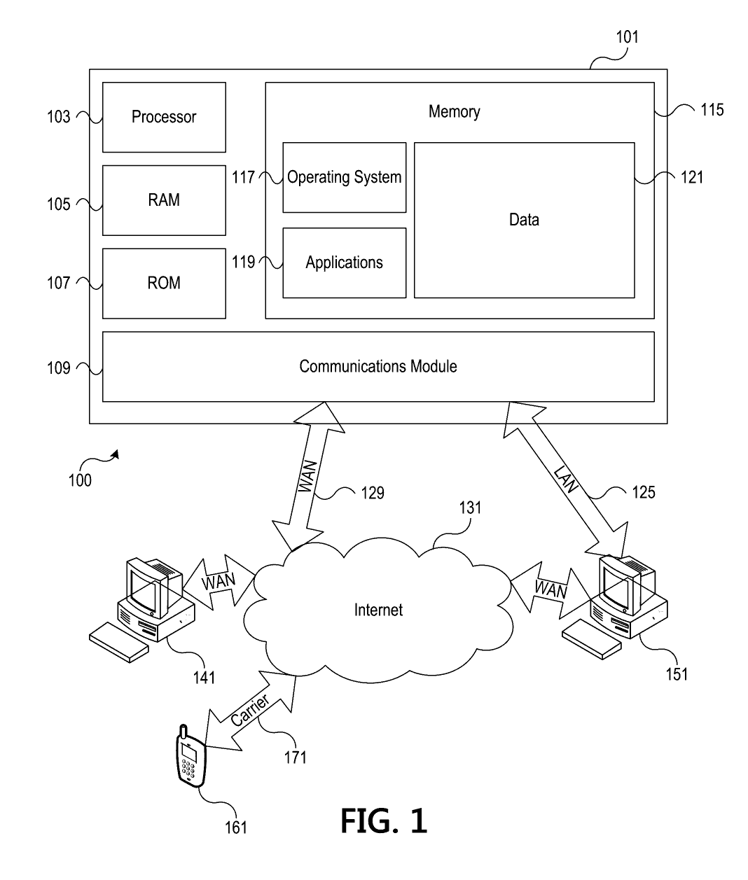

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks) are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

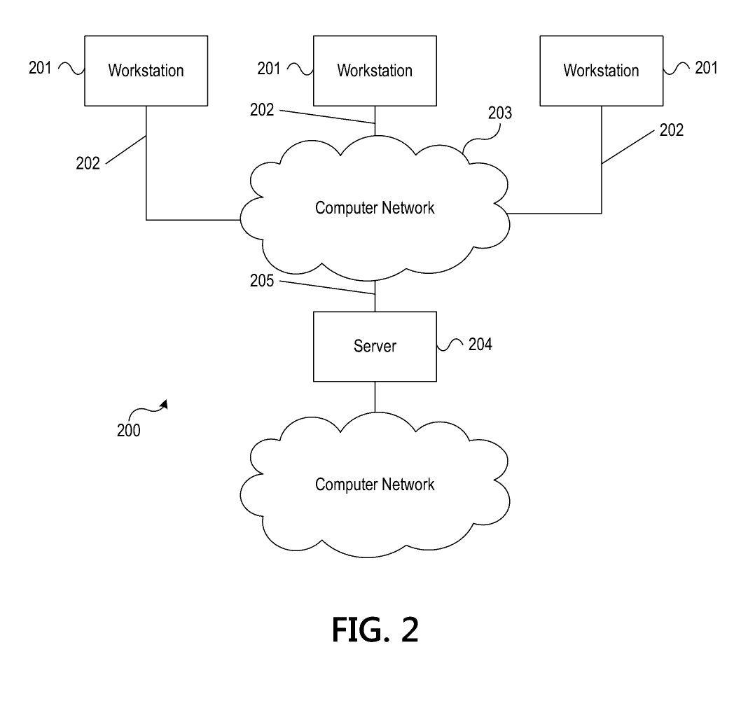

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

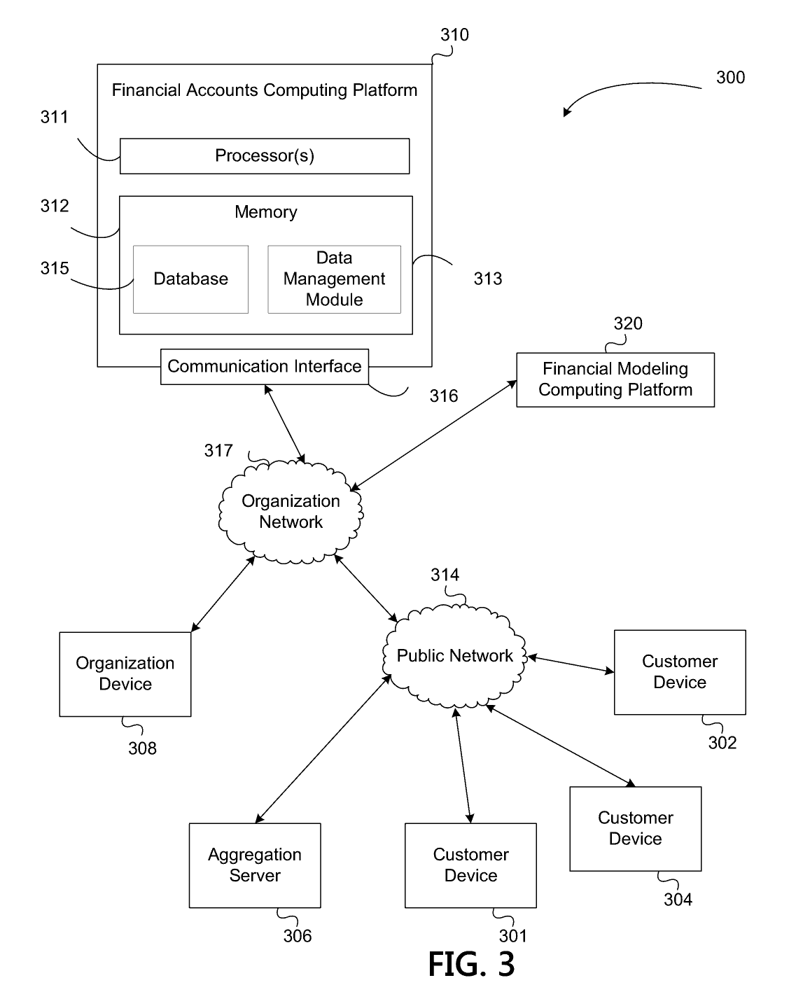

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like. FIG. 3 depicts an illustrative computing environment for aggregating financial data from one or more financial accounts maintained for a customer by one or more financial institutions into a portal in accordance with one or more example embodiments. Referring to FIG. 3, computing environment 300 may include one or more computing devices. For example, computing environment 300 may include a first customer device 301, a second customer device 302, a third customer device 304, and an organization device 308. First customer device 301, second customer device 302, and third customer device 304 may be used by one or more customers of the enterprise organization. Organization device 308 may, for example, be used by one or more financial advisors associated with the enterprise organization.

First customer device 301, second customer device 302, third customer device 304, and organization device 308 may be any type of computing device capable of receiving a user interface, receiving input via the user interface, and communicating the received input to one or more other computing devices. For example, first customer device 301, second customer device 302, third customer device 304, and organization device 308 may be a server computer, a desktop computer, laptop computer, tablet computer, smart phone, or the like. Any and/or all of first customer device 301, second customer device 302, third customer device 304, and organization device 308 may, in some instances, be special-purpose computing devices configured to perform specific functions.

Computing environment 300 also may include one or more computing platforms. For example, computing environment 300 may include financial accounts computing platform 310 and financial modeling computing platform 320. Financial accounts computing platform 310 may include one or more computing devices configured to perform one or more of the functions described herein. For example, financial accounts computing platform 310 may include one or more computers (e.g., laptop computers, desktop computers, servers, server blades, or the like). Financial accounts modeling platform 320 also may include one or more computing devices configured to perform one or more of the functions described herein. For example, financial modeling computing platform 320 may include one or more computers (e.g., laptop computers, desktop computers, servers, server blades, or the like).

Computing environment 300 also may include one or more networks, which may interconnect one or more of financial accounts computing platform 310, financial modeling computing platform 320, first customer device 301, second customer device 302, third customer device 304, and organization device 308. For example, computing environment 300 may include organization network 317 and public network 314. Organization network 317 and/or public network 314 may include one or more sub-networks (e.g., LANs, WANs, or the like). Organization network 317 may be associated with a particular organization (e.g., a corporation, financial institution, educational institution, governmental institution, or the like) and may interconnect one or more computing devices associated with the organization. For example, financial accounts computing platform 310, financial modeling computing platform 320, and organization device 308 may be associated with an organization (e.g., a financial institution), and organization network 317 may be associated with and/or operated by the organization, and may include one or more networks (e.g., LANs, WANs, VPNs, or the like) that interconnect financial accounts computing platform 310, financial modeling computing platform 320, and organization device 308 and one or more other computing devices and/or computer systems that are used by, operated by, and/or otherwise associated with the organization. Public network 314 may connect organization network 317 and/or one or more computing devices connected thereto (e.g., financial accounts computing platform 310, financial modeling computing platform 320, and organization device 308) with one or more networks and/or computing devices that are not associated with the organization. For example, aggregation server 306 might not be associated with an organization that operates organization network 317 (e.g., because aggregation server 306 may be owned and/or operated by one or more entities different from the organization that operates organization network 317, rather than being owned and/or operated by the organization itself or an employee or affiliate of the organization), and public network 314 may include one or more networks (e.g., the internet) that connect external aggregation server 306 to organization network 317 and/or one or more computing devices connected thereto (e.g., financial accounts computing platform 310, financial modeling computing platform 320, and organization device 308).

Financial accounts computing platform 310 may include one or more processors 311, memory 312, and communication interface 316. A data bus may interconnect processor(s) 311, memory 312, and communication interface 316. Communication interface 316 may be a network interface configured to support communication between financial accounts computing platform 310 and organization network 317 and/or one or more sub-networks thereof. Memory 312 may include one or more program modules having instructions that when executed by processor(s) 311 cause financial accounts computing platform 310 to perform one or more functions described herein and/or one or more databases that may store and/or otherwise maintain information which may be used by such program modules and/or processor(s) 311. For example, memory 312 may include data management module 313, which may include instructions that when executed by processor(s) 311 cause financial accounts computing platform 310 to perform one or more functions described herein, such as instructions for retrieving financial data for a third-party financial account as illustrated in greater detail below. In addition, memory 312 may include an external accounts database 315, which may store information associated with one or more customer accounts with one or more financial aggregator applications.

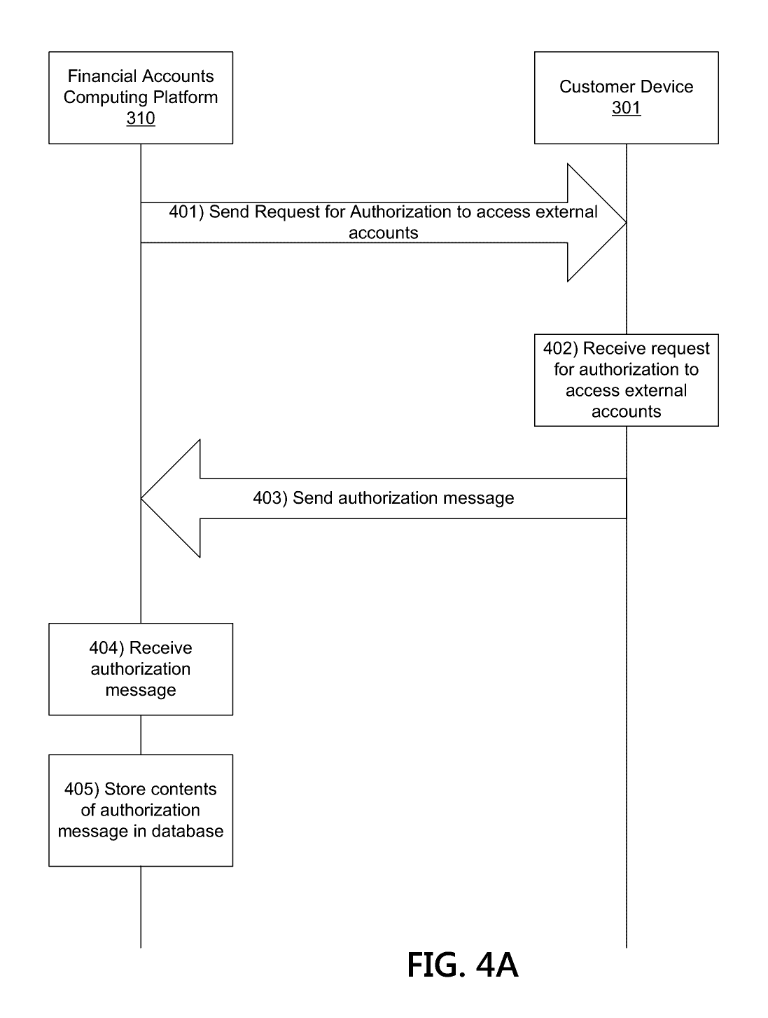

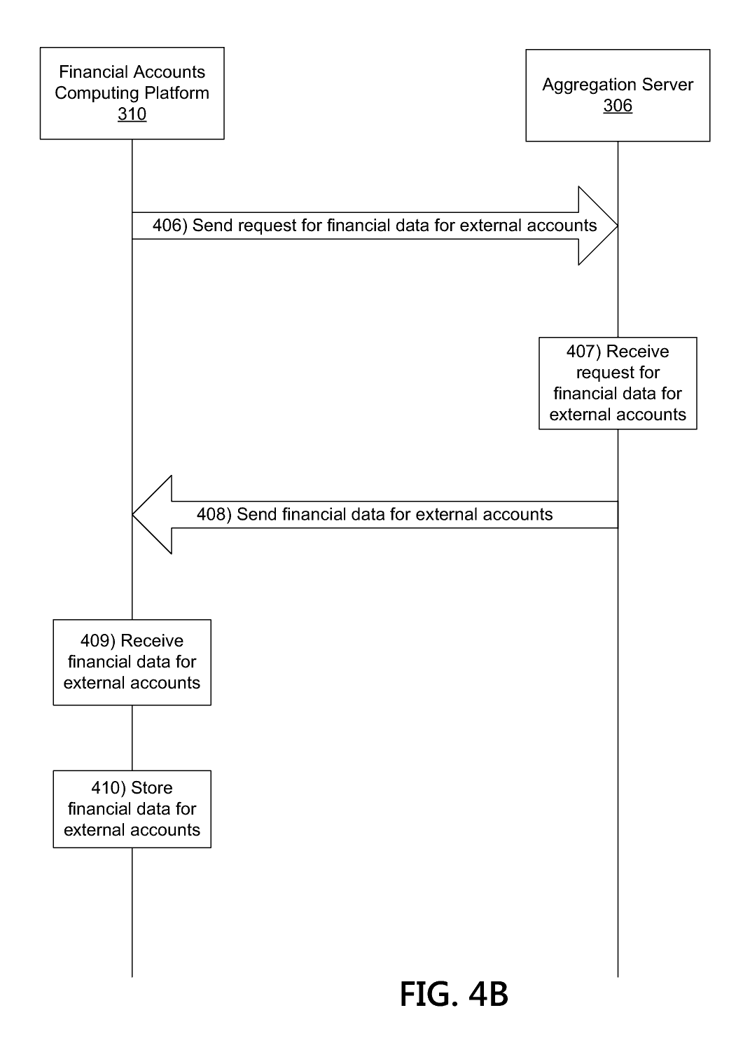

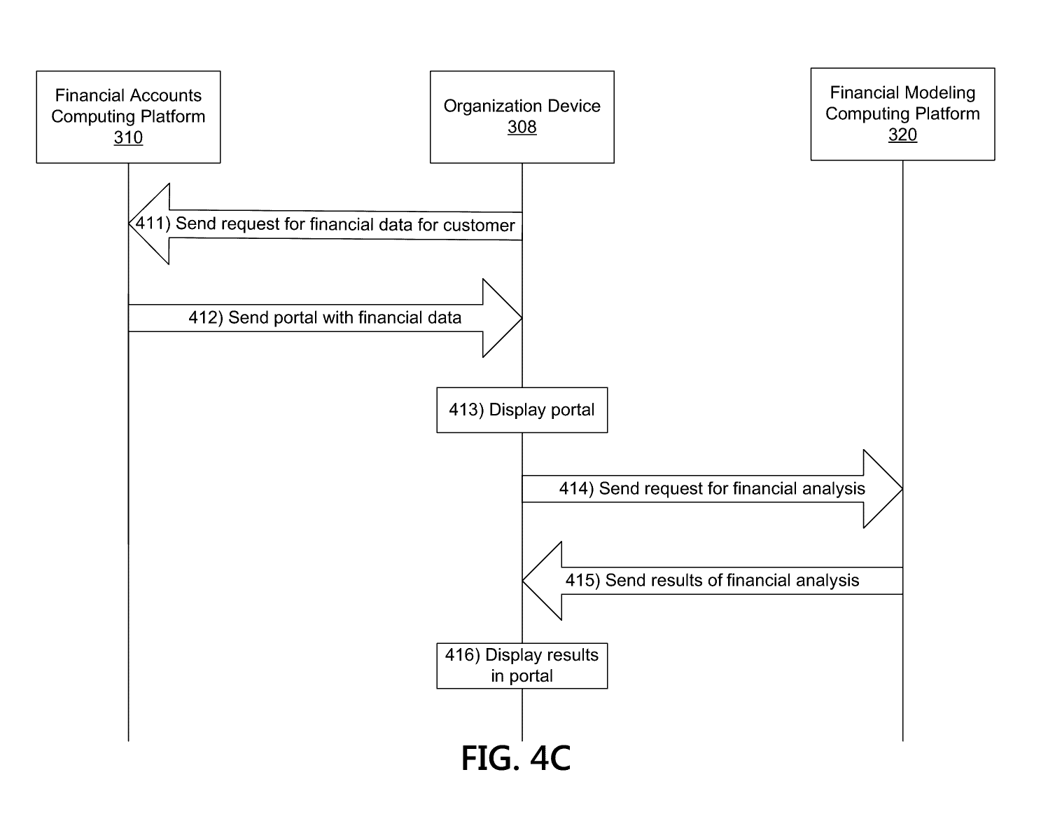

FIGS. 4A-4C an illustrative event sequence for aggregating financial data from one or more financial accounts maintained for a customer by one or more financial institutions into a portal in accordance with one or more example embodiments. Referring to FIG. 4A, at step 401, financial accounts computing platform 310 may send an authorization request to customer device 301. Financial accounts computing platform 310 may be used by, operated by, maintained by, and/or otherwise associated with an enterprise organization (e.g., a financial institution, as discussed above; hereinafter “internal financial institution”). Customer device 301 may be a computing device associated with a customer of the internal financial institution. For example, the internal financial institution may maintain one or more financial accounts for the customer.

The customer may have previously registered with a wealth management tool provided by the financial institution. The process of registering with the wealth management tool may include prompting the customer of the internal financial institution for identification information. The process of registering with the wealth management tool may further include assigning a financial advisor to the customer of the internal financial institution. The process of registering with the wealth management tool may further include prompting the customer of the internal financial institution to grant the wealth management tool access to the one or more financial accounts maintained for the customer by the internal financial institution. The process of registering with the wealth management tool may have further include prompting the customer of the internal financial institution to register with one or more financial aggregator applications. Each of these steps is discussed in detail below.

As noted above, the process of registering with the wealth management tool may include prompting the customer of the internal financial institution to enter identification information. The identification information may include, for the customer of the internal financial institution, a name, a home address, one or more telephone numbers (home, work, mobile, or the like), one or more email addresses, and/or social security number. An external account record may be created for the customer of the internal financial institution based on the entered identification information. The external account record may store all of the identification information entered by the customer.

An external account record may be created for each customer of the internal financial institution that registers for the wealth management tool. Each of the external account records may be stored on memory 312. Alternatively, the external account records may be stored on a separate memory or server device (not shown) connected to financial accounts computing platform 310 via organization network 317.

An account balance file may be created for the customer of the internal financial institution during the registration. Creating the account balance for the customer of the internal financial institution during registration may include storing the identification information entered by the customer of the internal financial institution in the account balance file. The wealth management account of the customer of the internal financial institution may be internally linked to the account balance file created for the customer of the internal financial institution. An advisor portal of the financial advisor assigned to the customer may be internally linked to the customer's account balance file.

A separate customer balance file may be created for each customer of the internal financial institution that registers for the wealth management tool. Each customer balance file may be stored in a central account data repository (not shown) maintained on memory 312. Alternatively, the central account data repository may be stored on a separate memory or server device connected to organization network 317.

As noted above, the process of registering with the wealth management tool may further include prompting the customer of the internal financial institution to consent to the wealth management tool accessing the one or more financial accounts maintained by the internal financial institution for the customer of the internal financial institution. Based on the consent provided by the customer of the internal financial institution, information for the one or more financial accounts maintained by the internal financial institution for the customer of the internal financial institution may be retrieved from one or more servers (not shown) associated with the internal financial institution via organization network 317. Retrieving the information may include retrieving, for each financial account maintained by the internal financial institution for the customer of the internal financial institution, the account number, the type of account, and the most recent account balance.

The retrieved information may be stored in the account balance file for the customer of the internal financial institution. A separate module may be created within the account balance file for each financial account maintained by the internal financial institution for the customer of the internal financial institution. Each module in the account balance may store, for a different financial account maintained for the customer by the internal financial institution, the account number, the type of account, and the most recent account balance.

As discussed below in reference to steps 401-410 of FIGS. 4A-C, financial accounts computing platform 310 may further store, in the account balance file for the customer of the internal financial institution, financial data from one or more third-party financial accounts maintained for the customer of the internal financial institution by one or more financial institutions different than the internal financial institution. The wealth management tool may retrieve, via the link to the account balance file for the customer of the internal financial institution, financial data for financial accounts maintained by the internal financial institution and financial data for third-party accounts maintained by one or more financial institutions different than the internal financial institution. The retrieved information may be presented within the wealth management tool for subsequent presentation to the customer of the internal financial account.

As noted above, the process of registering with the wealth management tool may include assigning a financial advisor to the customer of the internal financial institution. The financial advisor assigned to the customer may be presented with the information associated with the customer's financial accounts through a financial advisor portal. The financial advisor portal of the financial advisor assigned to the customer may be internally linked to the account balance file of the customer of the internal financial institution. An identification of the financial advisor assigned to the customer of the internal financial institution may be stored in the account balance file of the customer of the internal financial institution.

As noted above, the process of registering with the wealth management tool may include prompting the customer of the internal financial institution to register with one or more financial aggregator applications. An exemplary financial aggregator application may store financial data for one or more third-party financial accounts maintained for the customer of the internal financial institution by one or more financial institutions. The one or more financial institutions may be different than the internal financial institution. Registering with a financial aggregator application may require the customer of the internal financial institution to create a login ID and password for the financial aggregator application. An identification of the one or more financial aggregator applications that the customer of the internal financial institution registers with may be stored in the external account record for the customer of the internal financial institution.

The authorization request sent from financial accounts computing platform 310 to customer device 301 may be a request for permission to access, via a financial aggregator application, one or more third-party financial accounts maintained for the customer of the internal financial institution at one or more financial institutions that are different than the internal financial institution. The financial aggregator application may store financial information for the one or more third-party financial accounts maintained for the customer of the internal financial institution at one or more financial institutions that are different than the internal financial institution. If the customer of the internal financial institution has previously registered with multiple financial aggregator applications, financial accounts computing platform 310 may send out different authorization requests for each financial aggregator application with whom the customer of the internal financial institution has registered. Alternatively, financial accounts computing platform 310 may send out one authorization request to the customer of the internal financial institution, and the authorization request may include a separate request for each financial aggregator application with whom the customer of the internal financial institution is registered. Financial accounts computing platform 310 may send out a different authorization to each customer of the internal financial institution.

In one example, the internal financial institution may have a first customer (hereinafter “the first customer”) and a second customer (hereinafter “the second customer”). The first customer and second customer are merely meant to be illustrative, and the internal financial institution may have more than two customers. The first customer may be different than the second customer. The internal financial institution may maintain, for the first customer, a first financial account (hereinafter “the first internal financial account”) and a second financial account (hereinafter “the second internal financial account”). The first internal financial account may be a savings account. The second internal financial account may be a brokerage account. The internal financial institution may maintain, for the second customer, a third financial account (hereinafter “the third internal financial account”). The third internal financial account may be a retirement savings account, such as a 401K.

The first customer may be associated with a first customer computing device, such as customer device 302 (hereinafter “the first customer device”). The second customer may be associated with a second customer computing device, such as customer device 304 (hereinafter “the second customer device”). The internal financial institution may assign the first customer a first financial advisor (hereinafter “the first financial advisor”). The internal financial institution may assign the second customer a second financial advisor (hereinafter “the second financial advisor”).

The first customer may register with the wealth management tool and the second customer may register with the wealth management tool. During registration with the wealth management tool, the first customer may enter identification information, such as the first customer's name, home address, telephone number, email address, and/or social security number. Financial accounts computing platform 310 may create a first external account record (hereinafter “the first external account record”) for the first customer. Financial accounts computing platform 310 may store the first customer's identification information in the first external account record. Financial accounts computing platform 310 may further store the identification of the first financial advisor in the first external account record. The first external account record may be stored in memory 312. Financial accounts computing platform 310 may create a first customer account balance file (hereinafter “the first customer account balance file”) for the first customer. Financial accounts computing platform 310 may store the first customer's identification information and the identification of the first financial advisor in the first customer account balance.

Financial accounts computing platform 310 may present, to the first financial account, a first financial advisor portal (hereinafter “the first financial advisor portal”) containing the first customer's financial data. Financial accounts computing platform 310 may internally link the first customer's account with the wealth management tool to the first customer account balance file. Financial accounts computing platform 310 may internally link the first financial advisor portal to the first customer account balance file.

During registration with the wealth management tool, the first customer may be prompted to consent to the wealth management tool accessing the first internal financial account and the second internal financial account. Once the first customer provides the consent, financial accounts computing platform 310 may retrieve information for the first internal financial account and the second internal financial account from one or more servers associated with the internal financial institution. Retrieving the information for the first internal financial account and the second internal financial account may include retrieving, for each internal financial account, the account number, the type of account, and the most recent account balance.

Financial accounts computing platform 310 may store the retrieved information in the first customer account balance file. For example, financial accounts computing platform 310 may create two separate modules within the first customer account balance file. Financial accounts computing platform 310 may store, in the first module in the first customer account balance file (hereinafter “the first module in the first customer account balance file”), the account number, the type of account, and the most recent account balance, for the first internal financial account. Financial accounts computing platform 310 may store, in the second module in the first customer account balance file (hereinafter “the second module in the first customer account balance file”), the account number, the type of account, and the most recent account balance, for the second internal financial account.

During registration with the wealth management tool, the first customer may register with a first financial aggregator application (hereinafter “the first financial aggregator application”) and a second financial aggregator application (hereinafter “the second financial aggregator application”). The first financial aggregator application may store financial information for a first third-party financial account (hereinafter “the first third-party financial account”) maintained for the first customer by a first financial institution (hereinafter “the first financial institution”) and financial information for a second third-party financial account (hereinafter “the second third-party financial account”) and a third third-party financial account (hereinafter “the third third-party financial account”) maintained for the first customer by a second financial institution (hereinafter “the second financial institution”). The second financial aggregator application may store financial information for a fourth third-party financial account (hereinafter “the fourth third-party financial account”) maintained for the first customer by a third financial institution (hereinafter “the third financial institution”). Financial accounts computing platform 310 may create a first module in the first external account record (“hereinafter “the first module in the first external account record”). Financial accounts computing platform 310 may associate the first module in the first external account record with the first financial aggregator application. Financial accounts computing platform 310 may create a second separate module in the first external account record (“hereinafter “the second module in the first external account record”). Financial accounts computing platform 310 may associate the second module in the first external account record with the second financial aggregator application.

The internal financial institution, first financial institution, second financial institution, and third financial institution may each be different financial institutions. The first third-party financial account, the second third-party financial account, and the third third-party financial account may each be different types of accounts. For example, the first third-party financial account may be a checking account, the second third-party financial account may be a savings account, and the third third-party financial account may be a brokerage account. The fourth third-party financial account may be a brokerage account.

During registration with the wealth management tool, the second customer may enter identification information such as the second customer's name, home address, telephone number, email address, and/or social security number. The internal financial institution may assign the second customer a second financial advisor (hereinafter “the second financial advisor”) during the customer's registration with the wealth management tool. Financial accounts computing platform 310 may create a second customer external account record (hereinafter “the second external account record”) for the second customer. Financial accounts computing platform 310 may store the second customer's identification in the second external account record. The second customer external account record may be stored in memory 312. Financial accounts computing platform 310 may create a second customer account balance file (hereinafter “the second customer account balance file”) for the second customer. Financial accounts computing platform 310 may store the identification of the second financial advisor in the second customer account balance file.

Financial accounts computing platform 310 may present, to the second financial account, a second financial advisor portal (hereinafter “the second financial advisor portal”) containing the second customer's financial data Financial accounts computing platform 310 may internally link the second customer's account with the wealth management tool to the second customer account balance file. Financial accounts computing platform 310 may internally link the second financial advisor portal to the second customer account balance file.

During registration with the wealth management tool, the second customer may be prompted to consent to the wealth management tool accessing the third internal financial account. Once the second customer provides the consent, financial accounts computing platform 310 may retrieve information for the third internal financial account from one or more servers associated with the internal financial institution. Retrieving the information for the third internal financial account may include retrieving the account number, the type of account, and the most recent account balance. Financial accounts computing platform 310 may store the retrieved information in the second customer account balance file. Financial accounts computing platform 310 may create a first module within the second customer account balance file (hereinafter “the first module in the second customer account balance file”). Financial accounts computing platform 310 may store, in the first module in the second customer account balance file and for the third internal financial account, the account number, the type of account, and the most recent account balance.

During registration with the wealth management tool, the second customer may register with the second financial aggregator application and a third financial aggregator application (hereinafter “the third financial aggregator application”). The second financial aggregator application may store financial information for a fifth third-party financial account (hereinafter “the fifth third-party financial account”) maintained for the second customer by the first financial institution. The fifth third-party financial account may be a savings account. The third financial aggregator application may store financial information for a sixth third-party financial account (hereinafter “the sixth third-party financial account”) maintained for the second customer by a third financial institution (hereinafter “the third financial institution”). The internal financial institution and the third financial institution may be different financial institutions. The third financial aggregator application may be different than the first financial aggregator application and the second financial aggregator application. Financial accounts computing platform 310 may create a first module in the second external account record (“hereinafter “the first module in the second external account record”). Financial accounts computing platform 310 may associate the first module in the second external account record with the second financial aggregator application. Financial accounts computing platform 310 may create a second separate module in the second external account record (“hereinafter “the second module in the second external account record”). Financial accounts computing platform 310 may associate the second module in the second external account record with the third financial aggregator application.

Financial accounts computing platform 310 may send out a first authorization request (hereinafter “the first authorization request”) to customer device 302. The first authorization request may request consent to access the first customer's account with the first financial aggregator application. Financial accounts computing platform 310 may also send out a second authorization request (hereinafter “the second authorization request”) to customer device 302. The second authorization request may request consent to access the first customer's account with the second financial aggregator application. Financial accounts computing platform 310 may also send out a third authorization request (hereinafter “the third authorization request”) to customer device 304. The third authorization request may request permission to access the second customer's account with the second financial aggregator application and the second customer's account with the third financial aggregator application.

At step 402, the customer may receive the authorization request from financial accounts computing platform 310 at customer device 301. The customer may be notified of the authorization request by customer device 301 via one or more of an audio, visual, or tactile notification. Once the customer makes a selection in response to the authorization request, at step 403, customer device 301 may send an authorization message to financial accounts computing platform 310. The contents of the authorization message are based on the user's selections. At step 404, financial accounts computing platform 310 may receive the authorization message sent by customer device 301.

In a first instance, the customer may grant financial accounts computing platform 310 complete access to the customer's account with the financial aggregator application. The customer may further provide the customer's login credentials for the customer's account with the financial aggregator application. The login credentials may include a username and password. The authorization message sent from customer device 301 at step 403 may indicate that the customer has granted financial accounts computing platform 310 complete access to the customer's account with the financial aggregator application. The authorization message may further include the login credentials for the customer's account with the financial aggregator application. Here, financial accounts computing platform 310 may receive, via the communication interface, from the customer computing device, an authorization message from a customer of a first financial institution, the authorization message comprising authorization information indicating that the customer has authorized the first financial institution to access data related to a third-party financial account maintained for the customer by a second financial institution different than the first financial institution.

In a second instance, the customer may deny financial accounts computing platform 310 access to the customer's account with the financial aggregator application. The customer may not enter in the login credentials for the customer's account with the financial aggregator application, as access has been denied. In this instance, the authorization message sent from customer device 301 at step 403 may indicate that the customer has denied financial accounts computing platform 310 access to the customer's account with the financial aggregator application.

In a third instance, the customer may grant financial accounts computing platform 310 limited access to the customer's account with the financial aggregator application. That is, the customer may grant access to, via the customer's account with the financial aggregator application, the financial data for a first subset of third-party financial accounts, and may deny access to, via the customer's account with the financial aggregator application, the financial data for a second subset of third-party financial accounts. The first subset of third-party financial accounts and the second subset of third-party financial accounts may each include one or more third-party financial accounts. In this instance, the customer may provide financial accounts computing platform 310 with the customer's login credentials for the financial aggregator application and the account numbers for the third-party financial accounts to which access is granted. If the authorization message from financial accounts computing platform 310 to customer device 301 included requests for multiple financial aggregator applications, the customer's selection for each request may be any of the above, and the selection for each request may be different.

Continuing with the example above, in response to receiving the first authorization request at the first customer device, the first customer may select to grant financial accounts computing platform 310 limited access to the customer's account with the first financial aggregator application. The first customer may specify that financial accounts computing platform 310 may only access, via the first customer's account at the first financial aggregator application, financial data for the first third-party financial account and the second third-party financial account. The customer may make such a specification by providing the account numbers for the first third-party financial account and the second third-party financial account. The first customer may further specify that financial accounts computing platform 310 may not access, via the first customer's account with the first financial aggregator application, financial data for the third third-party financial account. The first customer may further provide the first customer's login credentials for the financial aggregator application. Based on the first user's selections, the first customer device may send a first authorization message (hereinafter “the first authorization message”) to financial accounts computing platform 310. The first authorization message may indicate that the first customer has granted financial accounts computing platform 310 limited access to the first customer's account with the first financial aggregator application. The first authorization message may further include the login credentials for the first customer's account with the first financial aggregator application. The first authorization message may further include the account numbers for the third-party financial accounts for which access has been granted.

In response to the second authorization request, the first customer may select to grant financial accounts computing platform 310 complete access to the customer's account with the second financial aggregator application. The first customer may provide the login credentials for the first customer's account with the second financial aggregator application. The first customer may not provide any account numbers for the third-party financial accounts stored in the first customer's account with the second financial aggregator application, as the first customer has granted financial accounts computing platform 310 complete access to the first customer's account with the second financial aggregator application. Based on the first customer's selections, the first customer device may send a second authorization message (hereinafter “the second authorization message”) to financial accounts computing platform 310. For example, financial accounts computing platform 310 may receive, via the communication interface, from the first customer device, the second authorization message from the first customer comprising second authorization information indicating that the customer has authorized the internal financial institution to access data related to the fourth third-party financial account maintained for the first customer by the second financial institution. The second authorization message may indicate that the first customer has granted financial accounts computing platform 310 complete access to the first customer's account with the second financial aggregator application. The second authorization message may further include the login credentials for the first customer's account with the second financial aggregator application.

In response to receiving the third authorization request at the second customer device, the second customer may select to grant financial accounts computing platform 310 complete access to the second customer's account with the second financial aggregator application. The second customer may provide the second customer's login credentials for the second financial aggregator application. The second customer may further select to deny financial accounts computing platform 310 access to the second customer's account with the third financial aggregator application. The second customer may not provide login credentials for the second customer's account with the third financial aggregator application. The second customer does not specify any account numbers, as the second customer has selected to grant complete access to the second customer's account with the second financial aggregator application and deny access to the second customer's account with the third financial aggregator application. Based on the second customer's selections, the second customer device may send a third authorization message (hereinafter “the third authorization message”) to financial accounts computing platform 310. The third authorization message may indicate that the second customer has granted financial accounts computing platform 310 complete access to the second customer's account with the second financial aggregator application. The third authorization message may further include the login credentials for the second customer's account with the second financial aggregator application. The third authorization message may further indicate that the second customer has denied financial accounts computing platform 310 access to the second customer's account with the third financial aggregator application.

At step 405, financial accounts computing platform 310 may store contents of the authorization message in a database. For example, financial accounts computing platform 310 may store the authorization information in an external account record associated with the customer and maintained in a database. Financial accounts computing platform 310 may store, in the customer's external account record and from the authorization message, an indication of whether the customer has granted complete access to the customer's account with the financial aggregator application, has denied access to the customer's account with the financial aggregator application, or has granted limited access to the customer's account with the financial aggregator application. Additionally, if the customer has granted complete or limited access to the customer's account with the financial aggregator application, financial accounts computing platform 310 may further store, in the customer's external account record, the login credentials for the customer's account with the financial aggregator application. Additionally, if the customer has granted limited access to the customer's account with the financial aggregator application, financial accounts computing platform 310 may further store, in the customer's external account record, the account numbers of the third-party financial account for which access has been granted. If the customer has registered with multiple financial aggregator applications, a separate module for each financial aggregator application may be created within the customer's external account record. Each module may store the aforementioned information for one of the multiple financial aggregator applications.

Continuing with the example above, the first module in the first external account record is associated with the first financial aggregator application and the second module in the first external account record is associated with the second financial aggregator application. Here, financial accounts computing platform 310, may store, based on the first authorization message and in the first module in the first external account record, an indication that the first customer has granted financial accounts computing platform 310 limited access to the first customer's account with the first financial aggregator application. Financial accounts computing platform 310 may further store, based on the first authorization message and in the first module in the first external account record, the login credentials for the first customer's account with the first financial aggregator application. Financial accounts computing platform 310, may further store, based on the first authorization message and in the first module in the first external record, account numbers for each of the first third-party financial account and the second third-party financial account, as the first customer has granted financial accounts computing platform 310 access to financial data for these specific third-party financial accounts.

Financial accounts computing platform 310 may store, based on the second authorization message and in the second module in the first external account record, an indication that the first customer has granted financial accounts computing platform 310 complete access to the first customer's account with the second financial aggregator application. Financial accounts computing platform 310 may further store, based on the second authorization message and in the second module in the first external account record, the login credentials for the first customer's account with the second financial aggregator application.

The first module in the second external account record is associated with the second financial aggregator application and the second module in the second external account record is associated with the third financial aggregator application. Here, financial accounts computing platform 310, may store, based on the third authorization message and in the first module in the second external account record, an indication that the second customer has granted financial accounts computing platform 310 complete access to the second customer's account with the second financial aggregator application. Financial accounts computing platform 310 may further store, based on the third authorization message and in the first module in the second external account record, the login credentials for the second customer's account with the second financial aggregator application. Financial accounts computing platform 310, may store, based on the third authorization message and in the second module in the second external account record, an indication that the second customer has denied financial accounts computing platform 310 access to the second customer's account with the third financial aggregator application.

Referring to FIG. 4B, at step 406, financial accounts computing platform 310 may send, via communication interface 316 and to aggregation server 306, a request for financial data for one or more third-party accounts maintained for the customer of the internal financial institution at one or more financial institutions. The one or more financial institutions may each be different than the internal financial institution. The request for financial data for the one or more third-party accounts may be sent to the financial aggregator application via one or more computer servers associated with the financial aggregator application that stores the requested financial data. The request for financial data may be based on the information stored in the external account record maintained for the customer. The request to the financial aggregator application may include the customer's login credentials for the financial aggregator application. The request for the financial aggregator application may include an indication of whether the customer has granted complete access or limited access to the customer's account with the financial aggregator application. In the case of the latter, the request for the financial aggregator application may further include an identification of the one or more third-party financial accounts that the customer has granted financial accounts computing platform 310 permission to access (such as the account numbers of these accounts). Where the internal financial institution has multiple customers that have each registered with the financial aggregator application, the request for financial data may be composed of multiple requests, each pertaining to a registered customer of the financial aggregator application and including one customer's login credentials for the financial aggregator application, an indication if the one customer has granted financial accounts computing platform 310 complete access or limited access to the one customer's account with the financial aggregator application, and optionally including an identification of the one or more third-party financial accounts that the one customer has granted financial accounts computing platform 310 permission to access.

Continuing with the example above, financial accounts computing platform 310 may send a first request for financial data (hereinafter “the first request for financial data”), via communication interface 316, to one or more computer servers associated with the first financial aggregator application. The information in the first request for financial data may be retrieved from the first external account record. The first request for financial data may include the first customer's login credentials for the first financial aggregator application. As the first customer has granted financial accounts computing platform 310 limited access to the first customer's account with the first financial aggregator application, the first request for financial data may further include the account numbers for the first third-party financial account and the second third-party financial account (i.e. the third-party financial account for which access has been granted).

Financial accounts computing platform 310 may send a second request for financial data (hereinafter “the second request for financial data”), via communication interface 316, to one or more computer servers associated with the second financial aggregator application. The second request for financial data may be composed of two separate requests, as both the first customer and the second customer have granted financial accounts computing platform 310 access to their respective accounts with the second financial aggregator application. The second request for financial data may include the first customer's login credentials for the second financial aggregator application and the second customer's login credentials for the second financial aggregator application. The second request for financial data may indicate that the first customer has granted complete access to the first customer's account with the second financial aggregator application. The second request for financial data may indicate that the second customer has granted complete access to the second customer's account with the second financial aggregator application. As both the first customer and the second customer have granted financial accounts computing platform 310 complete access to their respective accounts at the second financial aggregator application, no account numbers are specified in the second request for financial data. Financial accounts computing platform 310 does not sent a request for financial data to the third financial aggregator application (with whom the second customer has registered), as the second customer has denied financial accounts computing platform 310 access to the second customer's account with the third financial aggregator application.

At step 407, the financial aggregator application may receive, via one or more computer servers associated with the financial aggregator application, the request for financial data for one or more third-party financial accounts maintained for the customer of the internal financial institution by one or more financial institutions. The financial aggregator application may extract the login credentials from the request. The financial aggregator application may use the login credentials to certify the request. If the request is composed of multiple requests, the financial aggregator application may extract the login credentials from each request. The financial aggregator application may use each of the logic credentials to certify each of the requests.

Once the request has been validated, the financial aggregator application may retrieve information related to one or more third-party financial accounts maintained for the customer. The information may include, for one or more third-party financial accounts, the account number, the financial institution at which the third-party financial account is maintained, the type, and the most recent balance. If the type of the third-party financial account is brokerage, the retrieved information may include the asset class of the third-party financial account. If the request indicates that the customer has granted complete access to the customer's account with the financial aggregator application, the financial aggregator application may retrieve this information for all of the third-party financial accounts in the customer's account with the financial aggregator application. If the request indicates that the customer has granted limited access to the customer's account with the financial aggregator application, the financial aggregator application may retrieve the information for only those third-party financial accounts matching the account numbers specified in the request.

In one instance, the financial aggregator application may retrieve the most recent account balances for the one or more identified third-party financial accounts from the one or more financial institutions maintaining the one or more identified third-party financial accounts. In another instance, the financial aggregator application may retrieve the most recent account balances for the one or more identified third-party financial accounts from the one or more computer servers associated with the financial aggregator application. The received request may specify whether the financial aggregator application is to retrieve the most recent account balances for the one or more identified third-party financial accounts from the one or more computer servers associated with the financial aggregator application or from the one or more financial institutions maintaining the one or more identified third-party financial accounts.

Continuing with the example above, the first financial aggregator application may receive the first request for financial data via one or more computer servers associated with the first financial aggregator application. The first financial aggregator application may extract the login credentials for the first customer from the first request for financial data. The first financial aggregator application may utilize the extracted login credentials to validate the first request for financial data. Once the first request has been validated, the first financial aggregator application may determine, based on a specification in the first request for financial data, that the first customer has granted limited access to the first customer's account with the first financial aggregator application. The first financial aggregator application may then retrieve information for the specified third-party financial accounts (here, the first third-party financial account and the second third-party financial account). The first financial aggregator application may further determine, based on the contents of the first request for financial data that the financial information is to be obtained from the financial institution maintaining each of the third-party financial accounts.

The first financial aggregator application may retrieve, from one or more computer servers associated with the first financial aggregator application and for each of the first third-party financial account and the second third-party financial account, an identification of the financial institution maintaining the third-party financial account and the type of each account. The first financial aggregator application may then retrieve, from the first financial institution, the most recent balance of the first third-party financial account. The first financial aggregator application may then retrieve, from the second financial institution, the most recent account balance of the second third-party financial account.

The second financial aggregator application may receive the second request for financial data via one or more computer servers associated with the second financial aggregator application. The second financial aggregator application may extract the login credentials for the first customer and the login credentials for the second customer from the second request for financial data. The second financial aggregator application may utilize the extracted login credentials to validate the second request for financial data. Once the request has been validated, the second financial aggregator application may determine, based on a specification in the second request for financial data, that the first customer has granted complete access to the first customer's account with the second financial aggregator application. The second financial aggregator application may further determine, based on a specification in the second request for financial data, that the second customer has granted complete access to the second customer's account with the second financial aggregator application. The second financial aggregator application may determine, based on a specification in the second request for financial data, that the requested financial data is to be obtained from the one or more servers associated with the second financial aggregator application.

The second financial aggregator application may then retrieve the requested data for all of the third-party financial accounts stored in the first customer's account with the second financial aggregator application and all of the third-party financial accounts stored in the second customer's account with the second financial aggregator application. The second financial aggregator application may retrieve, from one or more servers associated with the second financial aggregator application, the account number for the fourth third-party financial account, an identification of the financial institution maintaining the fourth third-party financial account, the type of the fourth third-party financial account, the asset class of the fourth third-party financial account, and the most recent balance for the fourth third-party financial account. The second financial aggregator application may further retrieve, from one or more servers associated with the second financial aggregator application, the account number of the fifth third-party financial account, an identification of the financial institution maintaining the fifth third-party financial account, the type of the fifth third-party financial account, and the most recent balance of the fifth third-party financial account.

At step 408, the financial aggregator application may send, via the aggregation server 306 and to the financial accounts computing platform 310, a response to the request for financial data. The response to the request for financial data may include, for each third-party financial account identified in the request for financial data, the name of the customer associated with the third-party financial account and the information retrieved by the financial aggregator application (such as the account number, the financial institution maintaining the third-party financial account, the type, and the most recent account balance). The response may further include the asset class of the third-party financial account if the third-party financial account is a brokerage account. At step 409, financial accounts computing platform 310 may receive the response to the request for financial data. For example, financial accounts computing platform 310 may receive, via the communication interface 316, from one or more computer servers associated with the financial aggregator application, financial data related to the third-party financial account.

Financial accounts computing platform 310 may pre-process the financial data received in the response to align the format of the received financial data with a format used by the wealth management tool and the financial tools used by the financial advisor assigned to the customer, such as the financial advisor portal interface. The financial data received in the response from the financial aggregator application may be in a first format. A second format may be used by the wealth management tool and the financial advisor portal interface. Financial accounts computing platform 310 may pre-process the financial data received from the financial aggregator application to convert the financial data received from the financial aggregator application from the first format to the second format.

The second format may include multiple fields. Each field may be designated for a specified type of data. In one instance, the first field may designated for the account number of the third-party financial account, the second field may be designated for the account type of the third-party financial account, the third field may be designated for the financial institution maintaining the third-party financial account, and the fourth field may be designated for the most recent account balance of the third-party financial account. These fields are merely exemplary, and in another instance, the second format may include more, less, and/or different fields. For example, the second format may have a fifth field designated for the asset class of the third-party financial account.

Financial accounts computing platform 310 may first parse the response received from the financial aggregator application to extract the information required for the second format. Financial accounts computing platform 310 may extract, for each third-party financial account in the response, the account number of the third-party financial account, the name of the customer holding the third-party financial account, the type of the financial account, the financial institution maintaining the third-party financial account, an asset type of the third-party financial account, and the most recent balance of the third-party financial account. Financial accounts computing platform 310 may then locate the customer account balance file associated with the customer. Financial accounts computing platform 310 may locate the customer account balance file associated with the customer using the customer's name or other identifying information. Financial accounts computing platform 310 may then create, for each of the one or more third-party financial accounts identified in the response, a corresponding module in the customer account balance file. The corresponding module may have five fields aligned with the second format.

Continuing with the example above, financial accounts computing platform 310 may receive, via communication interface 116 and from the first financial aggregator application, a response to the first request for financial data (hereinafter “the first response”). Financial accounts computing platform 310 may parse the first response to extract the account number of the first third-party financial account, the name of the first customer, an indication that the first third-party financial account is a checking account, an indication that the first third-party financial account is maintained at the first financial institution, and the most recent balance for the first third-party financial account. Financial accounts computing platform 310 may further parse the first response to extract the account number for the second third-party financial account, the name of the first customer, an indication that the second third-party financial account is a savings account, an indication that the second third-party financial account is maintained at the second financial institution, and the most recent balance of the second third-party financial account.

As noted above, the first module in the first customer account balance file and the second module in the first customer account balance file store information on the first internal financial account and the second internal financial account. Financial accounts computing platform 310 may create a third module in the first customer account balance file (hereinafter “the third module in the first customer account balance file”) and a fourth module in the first customer account balance file (hereinafter “the fourth module in the first customer account balance file”). Each of the third module in the first customer account balance file and fourth module in the first customer account balance file may have five data fields, such that the format of the third module in the first customer account balance file and fourth module in the first customer account balance file is aligned with the second format.

Financial accounts computing platform 310 may also receive, via communication interface 116 and from the second financial aggregator application, a response to the second request for financial data (hereinafter “the second response”). Financial accounts computing platform 310 may parse the second response to extract the account number of the fourth third-party financial account, the name of the first customer, an indication that the fourth third-party financial account is a brokerage account, an indication that the asset class of the fourth third-party financial account is bonds, an indication that the fourth third-party financial account is maintained by the third financial institution, and the most recent balance for the fourth third-party financial account. Financial accounts computing platform 310 may further parse the second response to extract the account number of the fifth third-party financial account, the name of the second customer, an indication that the fifth third-party financial account is a savings account, an indication that the fifth third-party financial account is maintained by the second financial institution, and the most recent balance for the fifth third-party financial account.

As noted above, the first module in the second customer account balance file stores information on the third internal financial account. Financial accounts computing platform 310 may then create a fifth module in the first customer account balance file hereinafter “the fifth module in the first customer account balance file”) and a second module in the second customer account balance file hereinafter “the second module in the second customer account balance file”). Each of the fifth module in the first customer account balance file and the second module in the second customer account balance file may have five data fields, such that the format of the fifth module in the first customer account balance file and the second module in the second customer account balance file is aligned with the second format.

At step 410, financial accounts computing platform 310 may store the received financial data. For example, financial accounts computing platform 310 may store the financial data related to the third-party financial account in a central account data repository Financial accounts computing platform 310 may store the received financial data in the account balance file associated with the customer. The account balance file associated with the customer may been internally linked to the customer's account with the wealth management tool during the customer's registration with the wealth management tool. The account balance file associated with the customer may have been internally linked to the financial advisor portal interface during the customer's registration with the wealth management tool. The customer account balance file may be stored in the central account data repository (not shown). The central account data repository may be located within memory 312 of financial accounts computing platform 310. Alternatively, the central account data repository may be stored on a separate memory or server device (not shown) that is connected to organization network 317.

Financial accounts computing platform 310 may propagate, for each third-party financial account in the response received from the financial aggregator application, each of the five fields in the corresponding module in the account balance file associated with the customer of the internal financial institution with the information extracted by financial accounts computing platform 310 in step 409. For each third-party financial account in the response, financial accounts computing platform 310 may propagate the first field of the corresponding module with the parsed account number. For each third-party financial account in the response, financial accounts computing platform 310 may propagate the second field of the corresponding module with the parsed account type. For each third-party financial account in the response, financial accounts computing platform 310 may propagate the third field of the corresponding module with the parsed financial institution. For each third-party financial account in the response, financial accounts computing platform 310 may propagate the fourth field of the corresponding module with the parsed most recent account balance. For each third-party financial account in the response that is a brokerage account, financial accounts computing platform 310 may propagate the fifth field of the corresponding module with the parsed asset class. Once the fields in each of the corresponding module have been propagated, the financial data for each of the third-party financial accounts in the response is stored in a format compatible with the wealth management tool and the financial advisor portal interface (i.e. the second format).

Financial accounts computing platform 310 may then send a notification to the financial advisor assigned to the customer indicating that the financial data for one or more third-party financial account maintained for the customer by one or more financial institution is available for viewing by the financial advisor. Additionally, financial accounts computing platform 310 may continue to periodically refresh the financial information stored in the customer account balance file for each of the one or more third-party financial account accounts maintained for the customer by the one or more financial institutions. The information may be refreshed during predetermined time intervals, such as once every twenty-four hours, once every 7 days, or the like. Additionally, financial accounts computing platform 310 may refresh the financial data stored in the customer balance file outside of the predetermined time intervals if requested to do so by another system component via organization network 317 (for example, organization device 308 or financial modeling computing platform 320).

To obtain updated financial data, financial accounts computing platform 310 may first send a request for financial data to the one or more financial aggregator applications with whom the customer has registered. That is, once financial accounts computing platform 310 has received, via an authorization message, permission to access, via a financial aggregator application, financial data for one or more third-party financial accounts maintained for the customer of the internal financial institution by one or more financial institutions, financial accounts computing platform 310 may periodically request the financial data from the financial aggregator application. Financial accounts computing platform 310 may determine, from the external account record associated with the customer, each financial aggregator application with whom the customer has registered. Financial accounts computing platform 310 may further determine, from the external account record associated with the customer, the type of access granted for each financial aggregator application with whom the customer has registered. In response to the periodic requests from financial accounts computing platform 310, financial accounts computing platform 310 may periodically receive the updated financial data from the financial aggregator application. Financial accounts computing platform 310 may then pre-process the updated financial data and propagate the customer account balance file associated with the customer with the updated financial data.

Continuing with the example above, financial accounts computing platform 310 may propagate the fields of the third module in the first customer account balance file using the parsed information for the first third-party financial account. Financial accounts computing platform 310 may store the parsed account number for the first third-party financial account in the first field in the third module in the first customer account balance file. Financial accounts computing platform 310 may store the parsed account type for the first third-party financial account in the second field in the third module in the first customer account balance file. Financial accounts computing platform 310 may store the parsed first financial institution for the first third-party financial account in the third field in the third module in the first customer account balance file. Financial accounts computing platform 310 may store the parsed most recent account balance for the first third-party financial account in the fourth field in the third module in the first customer account balance file. Financial accounts computing platform 310 may propagate the first four fields of the fourth module in the first customer account balance file using the parsed information for the second third-party financial account in a similar manner.

Further continuing with the example above, financial accounts computing platform 310 may propagate the fields of the fifth module in the first customer account balance file using the parsed information for the fourth third-party financial account. Financial accounts computing platform 310 may store the parsed account number for the fourth third-party financial account in the first field in the fifth module in the first customer account balance file. Financial accounts computing platform 310 may store the parsed account type for the fourth third-party financial account in the second field in the fifth module in the first customer account balance file. Financial accounts computing platform 310 may store the parsed second financial institution for the fourth third-party financial account in the third field in the fifth module in the first customer account balance file. Financial accounts computing platform 310 may store the parsed most recent account balance for the fourth third-party financial account in the fourth field in the fifth module in the first customer account balance file. Financial accounts computing platform 310 may store the parsed asset class for the fourth third-party financial account in the fifth field in the fifth module in the first customer account balance file. Financial accounts computing platform 310 may propagate the fields of the second module in the second customer account balance file using the parsed information for the fifth third-party financial account in a similar manner.

After the financial data received from the first financial aggregator application and the second financial aggregator application has been stored in the corresponding modules for the first customer account balance file, financial accounts computing platform 310 may send the first advisor a notification that financial data related to one or more third-party financial accounts maintained for the first customer at one or more financial institutions different than the internal financial institution is available for viewing by the first financial advisor. After the financial data received from the second financial aggregator application has been pre-processed and stored in the corresponding modules for the second customer account balance file, financial accounts computing platform 310 may send the second advisor a notification that financial data related to one or more third-party financial accounts maintained for the second customer at one or more financial institutions different than the internal financial institution is available for viewing by the second financial advisor.

Additionally, financial accounts computing platform 310 may periodically refresh the stored financial data for each of the third-party financial accounts in the first customer account balance file and the financial data for each of the third-party financial accounts in the second customer account balance file. The stored financial data may be refreshed every twenty four hours. That is, every twenty-four hours, financial accounts computing platform 310 may send, based on the information stored in the first external account record, a request for financial data, via communication interface 316, to one or more computer servers associated with the first financial aggregator application. The request for financial data to the first financial aggregator application may include, from the first external account record, the first customer's login credentials for the first financial aggregator application, and indication that the first customer has granted limited access to the first customer's account with the first financial aggregator application, and the account numbers for the first third-party financial account and the second third-party financial account (i.e. the third-party financial accounts for which access has been granted). Financial accounts computing platform 310 may receive, via communication interface 116 and from the first financial aggregator application, a response to the request for financial data. Financial accounts computing platform 310 may parse, from the response, the most recent balance for the first third-party financial account and the most recent balance for the second third-party financial account. Financial accounts computing platform 310 may store the parsed most recent account balance for the first third-party financial account in the fourth field in the third module in the first customer account balance file. Financial accounts computing platform 310 may store the parsed most recent account balance for the second third-party financial account in the fourth field in the fourth module in the first customer account balance file. These steps may be repeated by the financial accounts computing platform 310 every twenty-four hours, or for any other time interval. These steps may be repeated by the financial accounts computing platform 310 outside of the time interval if requested by any device via organization network 317.

Every twenty-four hours, financial accounts computing platform 310 may additionally send, based on information stored in the first external account record and the second external account record, a request for financial data, via communication interface 316, to one or more computer servers associated with the second financial aggregator application. The request for financial data to the second financial aggregator application may include, from the first external account record, the first customer's login credentials for the second financial aggregator application and an indication that the first customer has granted complete access to the first customer's account with the second financial aggregator application. The request for financial data to the second financial aggregator application may include, from the second external account record, the second customer's login credentials for the second financial aggregator application and an indication that the second customer has granted complete access to the second customer's account with the second financial aggregator application.

Financial accounts computing platform 310 may receive, via communication interface 316 and from the second financial aggregator application, a response to the request for financial data. Financial accounts computing platform 310 may parse, from the response, the most recent balance for the fourth third-party financial account and the most recent balance for the fifth third-party financial account. Financial accounts computing platform 310 may store the parsed most recent account balance for the fourth third-party financial account in the fourth field in the fifth module in the first customer account balance file. Financial accounts computing platform 310 may store the parsed most recent account balance for the fifth third-party financial account in the fourth field in the second module in the second customer account balance file. These steps may be repeated by the financial accounts computing platform 310 every twenty-four hours, or for any other time interval. These steps may be repeated by the financial accounts computing platform 310 outside of the time interval if requested by any device via organization network 317. These steps may be repeated for the first external account record, the second external account record, or both.

Referring to FIG. 4C, at step 411, organization device 308 may send a request for financial data for the customer of the internal financial institution to financial accounts computing platform 310. Organization device 308 may be a financial advisor computing device used by the financial advisor associated with the customer. Organization device 308 may be a desktop computing device or may be a mobile computing device. Organization device 308 may send the request for financial data for the customer when prompted to do so by the financial advisor associated with the customer. The financial advisor may prompt the organization device 308 to send a request for the financial data via an advisor portal user interface.

The advisor portal user interface may be a graphical interface presented by organization device 308. The advisor portal user interface may be generated by a software application executing on organization device 308. Alternatively, the advisor portal user interface may be generated by a software application that is remotely executing on a computing device connected to organization device 308 via organization network 317. The request for financial data from organization device 308 may include identification information for the customer. The identification information may include the customer's name, home address, telephone number, email address, and/or social security number. Additionally, the identification information may include one or more account numbers, financial institutions, and/or account types.

Continuing with the example above, a computing device associated with the first financial advisor (for example, organization device 308; hereinafter “the first financial advisor computing device”) may send financial accounts computing platform 310 a request for financial data for the first customer. A computing device associated with the second financial advisor (hereinafter “the first financial advisor computing device”) may send financial accounts computing platform 310 a request for financial data for the second customer. The first financial advisor and the second financial advisor may be the same financial advisors or different financial advisors.

At step 412, financial accounts computing platform 310 may send a portal containing the requested financial data to organization device 308. Financial accounts computing platform 310 may first parse the request from organization device 308 to extract the identification information. Financial accounts computing platform 310 may then retrieve the customer's account balance file using the parsed identification information. Financial accounts computing platform 310 may then provide, for each module in the customer's account balance file, the data stored in one or more of the fields. If the request from organization device 308 specifies a particular account number, financial institution, or account type, financial accounts computing platform 310 may determine the one or more modules matching the specified information. In one instance, the request from organization device 308 may specify an account number. Financial accounts computing platform 310 may search the modules in the customer's account balance file to determine which module stores information for a financial account with the specified account number. Financial accounts computing platform 310 may then provide the data from one or more of the fields of that particular module.

Financial accounts computing platform 310 may provide the data in the form of an advisor portal user interface. For example, financial accounts computing platform 310 may provide, via the communication interface, to the financial advisor computing device used by the financial advisor associated with the customer, an advisor portal user interface, the advisor portal user interface comprising at least a portion of the financial data related to the third-party financial account maintained for the customer by one or more financial institutions different than the internal financial institution, and the advisor portal user interface further comprising a second financial data related to an internal financial account maintained for the customer by the internal financial institution. The financial data related to the third-party financial account maintained for the customer by one or more financial institutions different than the internal financial institution may be extracted from a module in the customer account balance file. The financial data related to an internal financial account maintained for the customer by the internal financial institution may be extracted from a different module in the customer account balance file.

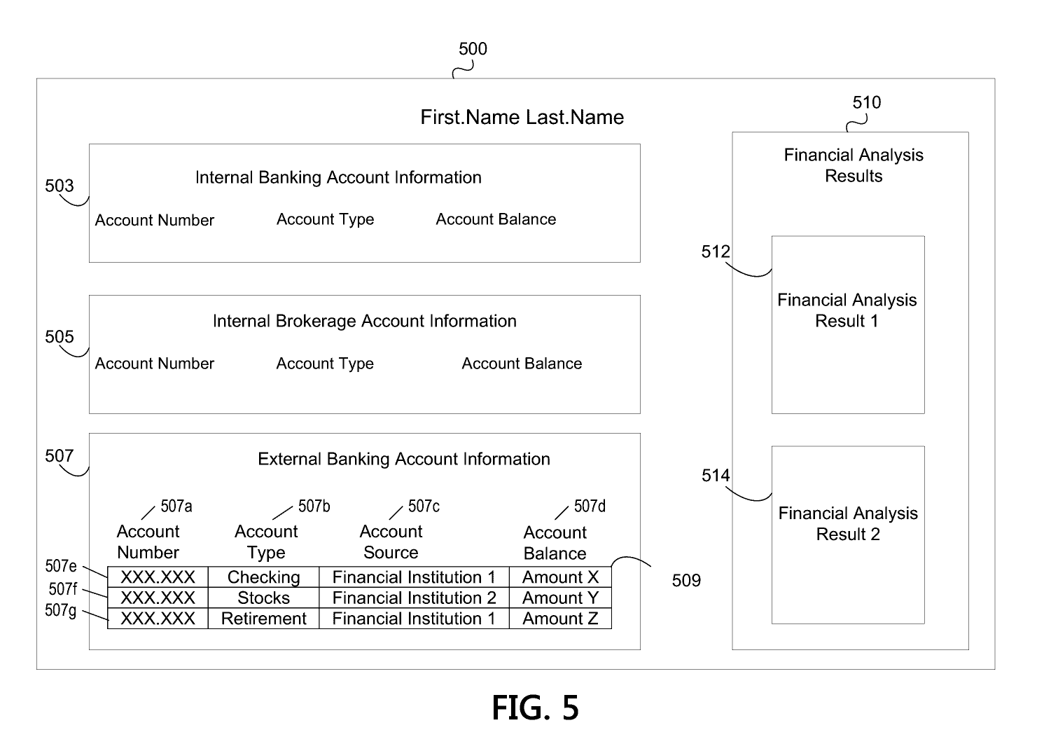

At step 413, organization device 308 may display and/or otherwise present the advisor portal user interface. FIG. 5 depicts an example graphical user interface for aggregating financial data from one or more financial accounts maintained for a customer by one or more financial institutions into a portal in accordance with one or more example embodiments. The presenting of advisor portal user interface may be compacted if organization device 308 is a mobile computing device. Element 501 of advisor portal user interface may indicate the name of the customer associated with the financial advisor (i.e. the customer for which the financial data was requested by the financial advisor). Element 503 of advisor portal user interface 500 may present the data related to the internal banking accounts maintained for the customer by the internal financial institution. Banking accounts may include savings accounts and checking accounts. The presented data may include the type of the account and the balance of the account. Element 505 of advisor portal user interface 500 may present the data related to the internal brokerage accounts maintained for the customer by the internal financial institution. The presented data may include the type of the account, the asset class of the account, and the balance of the account. Brokerage accounts may be related to stocks, bonds, money market instruments, real estate, commodities, and/or retirement plans.

Element 507 of advisor portal user interface 500 may present, in table 509, the data related to the third-party financial accounts maintained for the customer by the financial institutions different than the internal institution. The third-party financial accounts may include banking accounts (such as checking or savings) and/or brokerage accounts (such as stocks, bonds, money market instruments, real estate, commodities, and/or retirement plans). Each column of table 507 presents a different piece of information for the third-party financial account. Column 507a of table 509 may present the account number of each of the third-party financial accounts. Column 507b of table 509 may present the account type of each of the third-party financial accounts. Column 507c of table 509 may present an identification of the financial institution maintaining the third-party financial account for the customer. Column 507d of table 509 may present the most recent account balance for the third-party financial account. Each row of table 507 corresponds to a different third-party financial account. Here, row 507e represents a third-party savings account maintained for the customer by financial institution 1. Row 507f represents a third-party brokerage account (stocks) maintained for the customer by financial institution 2. Row 507g represents a third-party brokerage account (retirement) maintained for the customer by financial institution 1.

The financial advisor may add, remove, or edit any of the rows and/or columns in table 509. For example, the financial advisor may add another column to table 509 presenting the asset type of the third-party financial account. Table 509 is configurable, thus allowing the presentation of financial data to be tailored to the particular needs of the financial advisor and the customer. In one instance, the financial advisor may reconfigure table 509 to present only brokerage accounts (i.e. hide the display of row 507e).

Continuing with the example above, the first financial advisor computing device may receive a first advisor portal user interface (hereinafter “the first advisor portal user interface”). The first financial advisor computing device may present the first advisor portal user interface to the first financial advisor. Here, element 501 may present the name of the first customer. Element 503 may present information related to the first internal financial account and element 505 may present information related the second internal financial account. Row 507e may present information related to first third-party financial account. The first column of row 507e may present the account number of the first third-party financial account. The second column of row 507e may indicate that the first third-party financial account is a checking account. The third column of row 507e may indicate that the first third-party financial account is maintained by the first financial institution. The fourth column of row 507e may present the most recent balance of the first third-party financial account.

Row 507f may present information related to the second third-party financial account. The first column of row 507f may present the account number of the second third-party financial account. The second column of row 507f may indicate that the second third-party financial account is a savings account. The third column of row 507f may indicate that the second third-party financial account is maintained by the second financial institution. The fourth column of row 507f may present the most recent balance of the second third-party financial account.

Row 507g may present information related to the fourth third-party financial account. The first column of row 507g may present the account number of the fourth third-party financial account. The second column of row 507f may indicate that the fourth third-party financial account is a brokerage account. The third column of row 507g may indicate that the third-party financial account is maintained by the third financial institution. The fourth column of row 507g may present the most recent balance of the fourth third-party financial account. Information related to the third third-party financial account is not presented, as the first customer has not granted financial accounts computing platform 310 access to the financial information for this account.

Further continuing with the example above, the second financial advisor computing device may receive a second advisor portal user interface (hereinafter “the second advisor portal user interface”). The second financial advisor computing device may present the second advisor portal user interface to the second financial advisor. Here, element 501 may present the name of the second customer. Element 503 may present information related the third internal financial account. Element 505 is not presented here, as the internal financial institution does not maintain a brokerage account for the second customer. Row 507e may present information related to fifth third-party financial account. The first column of row 507e may present the account number of the fifth third-party financial account. The second column of row 507e may indicate that the fifth third-party financial account is a savings account. The third column of row 507e may indicate that the fifth third-party financial account is maintained by the second financial institution. The fourth column of row 507e may present the most recent balance of the fifth third-party financial account. Row 507f may not be presented here, as the second customer has denied financial accounts computing platform 310 access to the second customer's account with the third financial aggregator application (and the third financial aggregator application stores the financial information related to the sixth third-party financial account).

At step 414, organization device 308 may send a request for financial analysis to financial modeling computing platform 320. Organization device 308 may send the request for financial analysis based on a prompt received from the financial advisor via the advisor portal user interface 500 presented on the financial advisor computing device. The financial advisor may utilize the information from advisor portal user interface 500 as the basis for various types of financial analysis. The financial advisor may feed the information from advisor portal user interface 500 to one or more of a financial planning tool, an analytical modeling platform, a financial simulation tool, and/or a client reporting tool. These tools may perform financial simulation or forecasting using various statistical and/or probabilistic models. For example, one financial modeling tool may perform Monte Carlo simulation on the financial data. Another financial modeling tool may perform an asset allocation analysis on the financial data. The financial analysis may allow the financial advisor to compare the customer's current assets to the customer's financial goals. This allows the financial advisor to help the customer in planning for retirement, education, estates, or the like. These financial tools may execute locally on od 508 or may execute remotely at one or more computing devices connected to organization device 308 via organization network 317.

The financial advisor may select to perform the financial analysis on one or more of the financial accounts presented within elements 503, 505, and 507. The financial advisor may further select to include, as a basis for the financial analysis, other financial information that is not presented within elements 503, 505, and 507. The other financial information may be related to the customer's financial goals. The financial goals may be related to one of the financial accounts presented within advisor portal user interface 500. The other financial information may be manually entered by the financial advisor or may be retrieved from one of more financial planning tools.

At step 415, organization device 308 may display and/or otherwise present the results of the financial analysis within module 510 in advisor portal user interface 500. If the financial advisor requested a plurality of financial analyses, the result of each financial analysis may be displayed separately within module 510. For example, the results of a first financial analysis, such as a Monte Carlo simulation on the financial data, may be displayed within sub-module 512 of module 510. The results of a second financial analysis, such as an asset allocation analysis on the financial data, may be displayed within sub-module 514 of module 510. The financial advisor may review the results of the financial analysis as displayed in module 510. The financial advisor may perform additional financial analysis based on the results of the financial analysis. The results of the financial analysis may be transmitted to one or more computing devices on organization network 318. The results of the financial device may be transmitted to one or more customer computing devices via public network 314.

Continuing with the example above, the first financial advisor may select to perform a first financial analysis based on all of the financial information presented in the first advisor portal user interface. The first financial advisor may retrieve the first customer's financial goals from a financial planning tool. The first financial advisor may send the financial information from the first advisor portal user interface and the financial goals from the financial advisor computing device to a first analytical modeling platform. The first analytical modeling platform may be executing on financial modeling computing platform 320. The first analytical modeling platform may compare the first customer's current financial assets to the customer's financial goals. The first analytical modeling platform may further analyze the first customer's current financial assets to determine the estimated time frame within which the first customer's financial assets will meet the first customer's financial goals. The first analytical modeling platform may further perform an asset allocation analysis based on the received financial information. The first analytical modeling platform may send the results of the analysis to the first financial advisor computing device.

The first financial advisor computing device may present the results of the analysis to the first financial advisor within sub-module 512 of module 510 and sub-module 514 of module 510. The first financial advisor computing device may present the estimated time frame within which the first customer's financial assets will meet the first customer's financial goals within sub-module 512 of module 510. The first financial advisor computing device may present the results of the asset allocation analysis within sub-module 514 of module 510. The first financial advisor may view the results of the financial analysis on the first financial advisor computing device via sub-module 512 and sub-module 514 of module 510. The first financial advisor may further send the results of the financial analysis to the first customer via a client reporting tool. The results of the first financial analysis may be received by the first customer via the first customer device.

Further continuing with the example above, the second financial advisor may select to perform a second financial analysis based on the financial information presented in element 507 of the second advisor portal user interface. The second financial advisor may send the financial information from the second advisor portal user interface from the second financial advisor computing device to a second analytical modeling tool. The second analytical modeling platform may be executing on financial modeling computing platform 320. The second analytical modeling platform may perform a first projection of the fifth third-party financial account using a first financial model and a second projection of the fifth third-party financial account using a second financial model. For example, a Monte Carlo simulation may be performed. The first projection and the second projection are merely illustrative of various projections that may be performed, and the second analytical modeling platform may perform additional and/or different projections. The second analytical modeling platform may send the results of the financial analysis to the second financial advisor computing device.

The second financial advisor computing device may present the results of the analysis to the second financial advisor within sub-module 512 of module 510 and sub-module 514 of module 510. The second financial advisor computing device may present the results of the first projection within sub-module 512 of module 510. The second financial advisor computing device may present the results of the second projection within sub-module 514 of module 510. The second financial advisor may view the results of the financial analysis on the second financial advisor computing device via sub-module 512 and sub-module 514 of module 510. The second financial advisor may further send the results of the financial analysis to the second customer via a client reporting tool. The results of the financial analysis may be received by the second customer via the second customer device.

In one instance, the first financial advisor may be the same as the second financial advisor. The first financial advisor computing device may be the same as the second financial advisor computing device. The first financial advisor computing device may be the same as the second financial advisor computing device. Alternatively, the first financial advisor computing device may be different than the second financial advisor computing device. The first financial advisor computing device may be a desktop computing device. The second financial advisor computing device may be a mobile computing device. The first financial modeling tool may be the same as or different than the second financial modeling tool.

In another instance, the first financial advisor may be different than the second financial advisor. The first financial advisor computing device may be different from the second financial advisor computing device. The first financial modeling tool may be the same as or different than the second financial modeling tool.

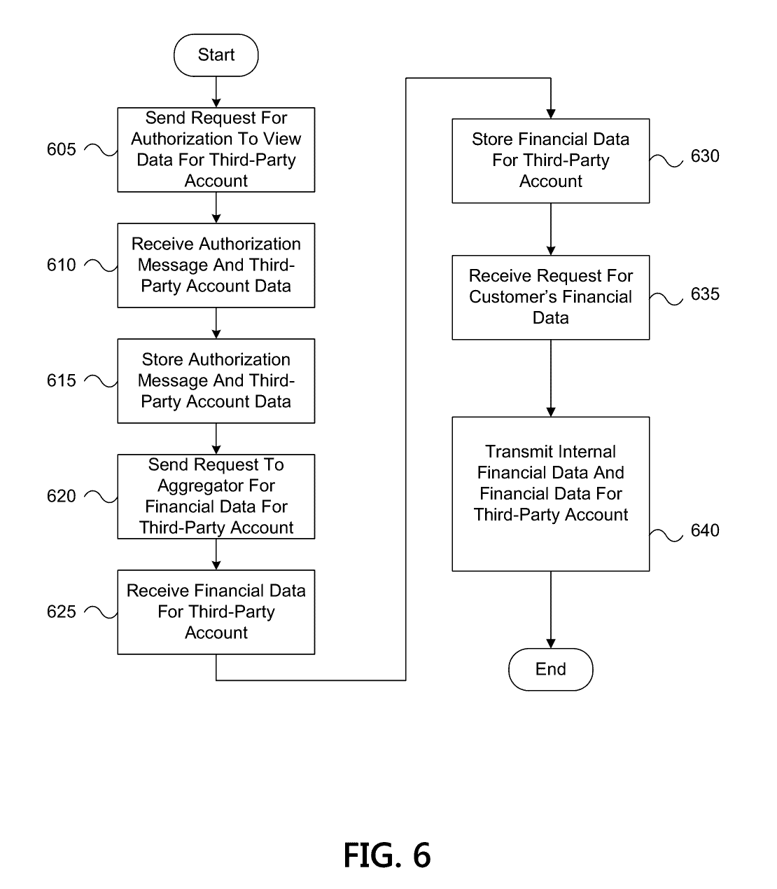

FIG. 6 depicts an illustrative method for aggregating financial data from one or more financial accounts maintained for a customer by one or more financial institutions into a portal in accordance with one or more example embodiments. Referring to FIG. 6, at step 605, a computing platform may send a request for authorization to view financial data related to one or more third-party financial accounts via one or more financial aggregator applications. At step 610, the computing platform may receive authorization to view related to one or more third-party financial accounts via one or more financial aggregator applications. At step 615, the computing platform may store the authorization message. At step 620, the computing platform may send a request to one or more financial aggregator applications for financial data one or more third-party financial accounts. At step 625, the computing platform may receive the financial data for the one or more third-party financial accounts. At step 630, the computing platform may store the received financial data for the one or more third-party financial accounts. At step 635, the computing platform may receive a request for a customer's financial data. Subsequently, at step 640, the computing platform may transmit the stored financial data for the one or more third-party financial accounts, as well as stored financial data for an internal account maintained for the customer.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A system, comprising:
at least one processor;
a communication interface; and
memory storing computer-readable instructions that, when executed by the at least one processor, cause the system to:
receive, via the communication interface, from a customer computing device, an authorization message from a customer of a first financial institution, the authorization message comprising authorization information indicating that the customer has authorized the first financial institution to access data related to a third-party financial account maintained for the customer by a second financial institution different than the first financial institution;
store the authorization information in an external account record associated with the customer and maintained in a database;
receive, via the communication interface, from one or more computer servers associated with an external aggregator, financial data related to the third-party financial account;
store the financial data related to the third-party financial account in a central account data repository; and
provide, via the communication interface, to a financial advisor computing device used by a financial advisor associated with the customer, an advisor portal user interface, the advisor portal user interface comprising at least a portion of the financial data related to the third-party financial account maintained for the customer by the second financial institution different than the financial institution, and the advisory portal user interface further comprising second financial data related to a first financial account maintained for the customer by the first financial institution.

2. The system of claim 1, wherein the memory stores additional computer-readable instructions that, when executed by the at least one processor, further cause the system to:
receive, via the communication interface, from the customer computing device, a second authorization message from the customer comprising second authorization information indicating that the customer has authorized the first financial institution to access data related to a second third-party financial account maintained for the customer by a third external financial institution different than the first financial institution and the second financial institution;
store the second authorization information in the external account record associated with the customer;
retrieve third financial data related to the second third-party financial account; and
provide, to the advisor portal user interface, the third financial data related to the second third-party financial account maintained for the customer by the third financial institution.

3. The system of claim 2, wherein retrieving third financial data related to the second third-party financial account comprises retrieving, via the communication interface, from the one or more computer servers associated with the external aggregator, third financial data related to the second third-party financial account.

4. The system of claim 2, wherein retrieving financial data related to the second third-party financial account comprises retrieving, via the communication interface, from one or more computer servers associated with a second external aggregator, financial data related to the second third-party financial account.

5. The system of claim 1, wherein the memory stores additional computer-readable instructions that, when executed by the at least one processor, further cause the system to:
receive, via the communication interface, from a second customer computing device, a second authorization message from a second customer of the first financial institution, the second authorization message comprising second authorization information indicating that the second customer has authorized the first financial institution to access data related to a second third-party financial account maintained for the second customer by a third financial institution different than the first financial institution, wherein the second customer is different than the customer;
store in a second external account record associated with the second customer and maintained in the database;
retrieve, via the communication interface, from the one or more computer servers associated with the external aggregator, third financial data related to the second third-party financial account;
store the third financial data related to the second third-party financial account in the central account data repository;
provide, via the communication interface, to a second financial advisor computing device used by a second financial advisor associated with the second customer, a second advisor portal user interface, the second advisor portal user interface comprising at least a portion of the third financial data related to the second third-party financial account maintained for the second customer by the third financial institution, and the second advisory portal user interface further comprising fourth financial data related to a second financial account maintained for the second customer by the first financial institution.

6. The system of claim 5, wherein the financial advisor and the second financial advisor are the same.

7. The system of claim 5, wherein the financial advisor and the second financial advisor are different.

8. The system of claim 1, wherein retrieving, via the communication interface, from the one or more computer servers associated with the external aggregator, financial data related to the third-party financial account comprises periodically retrieving, via the communication interface, from the one or more computer servers associated with the external aggregator, financial data related to the third-party financial account.

9. The system of claim 1, wherein the memory stores additional computer-readable instructions that, when executed by the at least one processor, further cause the system to:
provide, to the advisor portal user interface, an asset allocation based on the financial data related to the third-party financial account and the second financial data related to the first financial account.

10. The system of claim 1, wherein the memory stores additional computer-readable instructions that, when executed by the at least one processor, further cause the system to:
send, via the communication interface, to a computing platform associated with the first financial institution and configured to provide an analytical modeling platform, the financial data related to the third-party financial account for processing by the analytical modeling platform.

11. The system of claim 1, wherein the memory stores additional computer-readable instructions that, when executed by the at least one processor, further cause the system to:
send, via the communication interface, to a computing platform associated with the first financial institution and configured to provide a client reporting platform, the financial data related to the third-party financial account for processing by the client reporting platform.

12. A method, comprising:
at a first computing platform comprising at least one processor, a communication interface, and memory:
receiving, via the communication interface and from a customer computing device, an authorization message from a customer of a first financial institution, the authorization message comprising authorization information indicating that the customer has authorized the first financial institution to access data related to a third-party financial account maintained for the customer by a second financial institution different than the first financial institution;
storing the authorization message and an identification of a financial advisor associated with the customer in an external account record associated with the customer of the first financial institution and maintained in a database;
retrieving, via the communication interface, from one or more computer servers associated with an external aggregator, financial data related to the third-party financial account;
storing the financial data related to the third-party financial account in a central account data repository; and
providing, via the communication interface, to a financial advisor computing device used by a financial advisor associated with the customer, an advisor portal user interface, the advisor portal user interface comprising at least a portion of the financial data related to the third-party financial account maintained for the customer by the second financial institution different than the first financial institution, and the advisory portal user interface further comprising second financial data related to a first financial account maintained for the customer by the first financial institution.

13. The method of claim 12, further comprising:
receiving, via the communication interface, from the customer computing device, a second authorization message from the customer comprising second authorization information indicating that the customer has authorized the first financial institution to access data related to a second third-party financial account maintained for the customer by a third financial institution different than the first financial institution and the second financial institution;
storing, in the external account record associated with the customer of the first financial institution, the second authorization information;
retrieving third financial data related to the second third-party financial account; and
providing, to the advisor portal user interface, the third financial data related to the second third-party financial account.

14. The method of claim 13, wherein retrieving third financial data related to the second third-party financial account comprises retrieving, via the communication interface, from the one or more computer servers associated with the external aggregator, third financial data related to the second third-party financial account.

15. The method of claim 13, wherein retrieving third financial data related to the second third-party financial account comprises retrieving, via the communication interface, from one or more computer servers associated with a second external aggregator different than the external aggregator, third financial data related to the second third-party financial account.

16. The method of claim 12, further comprising:
receiving, via the communication interface, from a second customer computing device, a second authorization message from a second customer of the first financial institution, the second authorization message comprising second authorization information indicating that the second customer has authorized the first financial institution to access data related to a second third-party financial account maintained for the second customer by a third financial institution different than the first financial institution, wherein the second customer is different than the customer;
storing the second authorization message in a second external account record associated with the second customer and maintained in the database;
retrieving, via the communication interface, from the one or more computer servers associated with the external aggregator, third financial data related to the second third-party financial account;
storing the third financial data related to the second third-party financial account in the central account data repository;
providing, via the communication interface, to a second financial advisor computing device used by a second financial advisor associated with the second customer, a second advisor portal user interface, the second advisor portal user interface comprising at least a portion of the third financial data related to the second third-party financial account maintained for the second customer by the third financial institution, and the second advisory portal user interface further comprising fourth financial data related to a second financial account maintained for the second customer by the first financial institution.

17. The method of claim 16, wherein the financial advisor and the second financial advisor are the same.

18. The method of claim 16, wherein the financial advisor and the second financial advisor are different.

19. The method of claim 15, further comprising sending, via the communication interface, to a computing platform associated with the first financial institution and configured to provide one or more of an analytical modeling platform, an asset allocation platform, and a client reporting platform, the financial data related to the third-party financial account for processing.

20. One or more non-transitory computer-readable media storing instructions that, when executed by a computer system comprising at least one processor and memory, cause the computer system to:
at least one processor;
a communication interface; and
memory storing computer-readable instructions that, when executed by the at least one processor, cause the system to:
receive, via the communication interface, from a customer computing device, an authorization message from a customer of a first financial institution, the authorization message comprising authorization information indicating that the customer has authorized the first financial institution to access data related to a third-party financial account maintained for the customer by a second financial institution different than the first financial institution;
store the authorization information in an external account record associated with the customer, wherein the second external account record is maintained in the database;
retrieve, via the communication interface, from one or more computer servers associated with an external aggregator, financial data related to the third-party financial account;
store the financial data related to the third-party financial account in a central account data repository; and
provide, via the communication interface, to a financial advisor computing device used by a financial advisor associated with the customer, an advisor portal user interface, the advisor portal user interface comprising at least a portion of the financial data related to the third-party financial account maintained for the customer by the second financial institution different than the financial institution, and the advisory portal user interface further comprising second financial data related to a first financial account maintained for the customer by the first financial institution.
